(19) United States
(12) Patent Application Publication
(10) Pub. No.: US 2013/0182456 A1
(43) Pub. Date: Jul. 18, 2013

(54) Edge type LED backlight unit

(71) Applicant: Huei-dung Chin, Taipei (TW)

(72) Inventor: Huei-dung Chin, Taipei (TW)

(21) Appl. No.: 12/940,065

(22) Filed: Nov. 5, 2010

(51) Int. Cl. F21V 8/00

(52) U.S. Cl. CPC G02B 6/0023
USPC 362/608; 264/1.25

(57) ABSTRACT

A LED backlight unit structure, especially a edge type LED backlight unit, which had a substrate and a one or plurality LED light source lay on the substrate, and a light guide plate 101, which directly couple with the one or plurality LED by using the insert molding technology. A light modulation structure thereon the light guide plate, where near the one or plurality LED light source. A LED backlight unit structure, also can apply light tube or reflecting structure on the light guide plate, and that also can combined with the above-mentioned structures.

### TECHNICAL FIELD

The present of disclosure is related LED backlight unit, particularly edge type LED backlight unit, which had light modulation structure to modulating beam profile and enhance light efficiency.

### BACKGROUND

LED (Light emission diode) as LCD backlight, because it has high color saturation, mercury-free, life up to 100,000 hours, that can replace the CCFL (Cold cathode fluorescence lamp, the following referred to as CCFL) backlight products. LED light source of the backlight module, due to its “high sophistication,” “high brightness”, “no mercury” and “high color reproducibility,” and so on, so it can give a higher value-added LCD panel, unlike the LED always only give people the “space saving” the impression is generally believed that the future application of LED backlight modules, will cross the threshold of portable electronic devices, quickly spread to the cars, displays, television and other fields.

In fact the industry based on considerations of product differentiation, has introduced LED backlighting LCD panels is the use of LED response rate three times faster than the cold cathode fluorescent lamp features three types of LED light source with RGB, high-speed switching point sequence light, such LCD panel can replace high-priced addition to color filters, the more increased the sophistication and LCD brightness. Samsung SDI has therefore decided to use the technology, with recent mass production of LCD panels for mobile phones, the future scope of application will extend to digital video cameras and notebook computers, compared SHARP is focused on mercury-free LED and high color reproduction so on, and tried to give car product differentiation, and reached no mercury pollution of the environmental claims, but can also make DVD when the show received high color reproducibility.

LED backlight light source according to the current design, one for the side into the design, its for major improvements is the LED light source of the light side, and to surface-mount package designed to save space. As the LCD backlight, learning to know the side-emitting type LED compared to cold cathode fluorescent lamp, a small light-emitting surface of the backlight can be reduced thickness. In addition to the above advantages, the optical coupling efficiency and the package thickness of the backlight light source modules are better than the CCFL backlight. Learn to know the side entry type LED design, general use of long-type or small LED, encapsulated surface mount components and minimize the thickness of the entire package to increase the optical coupling efficiency.

However, the use of this design LED backlight light source is not without drawbacks, as compared to CCFL LED light source area of a small number, most people will be LED as a point light source, so you must use multiple satellites LED array, this way, the LED backlight light source will be formed between the so-called dark zone. In addition, the future will continue into the slim LCD design of the same time, the backlight light source of the light guide plate thickness will be thinner compared with the width of the LED, can not be regarded as point light sources. On the other hand, thinner light guide plate, the coupling efficiency will be reduced into the light.

However, the use of this design LED backlight light source is not without drawbacks, as compared to CCFL LED light source area of a small number, most people will be LED as a point light source, so you must use multiple satellites LED array, this way, the LED backlight light source will be formed between the so-called dark zone. In addition, the future will continue into the slim LCD design of the same time, the backlight light source of the light guide plate thickness will be thinner compared with the width of the LED, can not be regarded as point light sources. On the other hand, thinner light guide plate, the coupling efficiency will be reduced into the light.

In general, should know the LED light source use in backlight unit, in the shape of the emphasis on simple and small, so the optical design has not really used to optimize the design, only some little do change. In the future, LCD backlight unit will thinner than ever. By way of decreasing the thickness of light guide plate, this design also inevitably has its design limitations. The improvements of LED backlight unit structure design proceeding, the power efficiency, less thickness of backlight unit still main problems in the future backlight unit designation.

### SUMMARY

The present disclosure provides a LED backlight unit design structure, particularly for variety of TFT LCD screen of backlighting, or other planar light source illuminations. The invention of the new LED backlight module design structure, to improve the LED light source into the light guide plate of the coupling efficiency of optical system to reduce power consumption. Furthermore, the present invention of light guide plate structure can modulate the light direction, and without or very little loss, that can further achieve the luminous efficiency of LED backlight modules.

The present disclosure further proposed a structure of the LED backlight module structures, that LED light can further modulated, making the LED backlight module can be more efficient and more flexible in design.

According to the disclosure of the proposed LED backlight module design structure, the LED light guide plate can couple with LED light source, by using the insert molding technologies. LED light guide plate couple with LED light source directly, then can increase the coupling efficiency of LED light sources, and moreover that can increase the LED light source and the combination of backlight accuracy.

Moreover, according to the present of disclosure of the LED backlight unit design structure, further provide a light modulation structure on the light guide plate, which LED light source of intrinsic beam profile in the light guide plate can be modulated in advanced.

According the present disclosure LED backlight unit design structure, and light guide plate couple LED light source by using insert molding technologies directly, which design can further adding hollow cavities of the structure, or be inserted in highly reflective materials structure therein, that can achieve the efficiency of the LED light source modulation. This structure can be combined with the previous design, or alone, to increase the performance of the backlight module, or increase design flexibility.

The present disclosure of LED backlight unit structure, and light guide plate couple LED light source by using insert molding technologies directly, and further proposed LED different locations in order to apply to the use of single LED backlight module design. Moreover, with variant light modulation structure designed to achieve better design of the LED backlight unit. And furthermore the present invention has a bent or cambered shape, to increase the ability to control the light source of beam profile, or to improve their uniformity.

The present disclosure of LED backlight unit design structure, and the light guide plate couple the LED light source by using insert molding technologies directly, and further included a structure of light tube design, which near the LED light source. This structure can use in color LED light source, such as R, G, B color LED light sources, the light tube structure making the LED color light mix in the light tube in advanced, to increase the uniformity.

The present disclosure LED backlight unit design structures, and the light guide plate couple the LED light source by using insert molding technologies directly, and included a set of structures on the light guide plate, that the structure of can apply on smart lighting of TFT LCD displayer. By control of the light guide plate segments independently, which segments by the structure, and the LED backlight unit can synchronize with the TFTLCD control, in order to achieve the savings in light efficiency further.

### BRIEF DESCRIPTION OF THE DRAWING

So that those have ordinary skill in art to which the subject disclosure, exemplary embodiments thereof will be described below the drawing, in which:

FIGS. 1-1 is an explore perspective view of directly couple LED backlight unit;

FIGS. 1-2 is a cross-sectional diagram of FIG. 1-1, which add a hole structure;

FIGS. 1-3 is another cross-sectional diagram of FIG. 1-1, which insert a high reflection material structure;

FIG. 2 is an explore perspective view of LED backlight unit with array modulation structures;

FIG. 3 is an explore perspective view of LED backlight unit with cornered shape;

FIG. 4 is an explore perspective view of LED backlight unit with LED light source set on the corners of the light guide plate;

FIG. 5 is an explore perspective view of LED backlight unit, which designed for R•G•B LED color light source;

FIG. 6-1 cross-sectional diagram of LED backlight unit for the smart backlight design; and

FIGS. 6-2 is another cross-sectional diagram of FIG. 6-1.

### DETAILED DESCRIPTION

The better implementation of the present disclosure will be described in detail cases and point of view, but such a narrative explanation of the disclosure system structure and process, only to illustrate and not to limit the scope of this invention patent. Therefore, in addition to the description of a better implementation of the cases, the present invention can be implemented widely applied in other cases.

Looking at this description of an implementation of the so-called cases or a description of the implementation of cases refers to one of its special relations connecting the features, structure or feature, it also contains at least one implementation of this invention within. Therefore, throughout the description of the implementation of the cases arising from the implementation of legislation or a one embodiment, without specifying the implementation of cases is the same. In addition, some special characteristics, structure or feature can also be implemented in one or more of the cases combined in any appropriate manner.

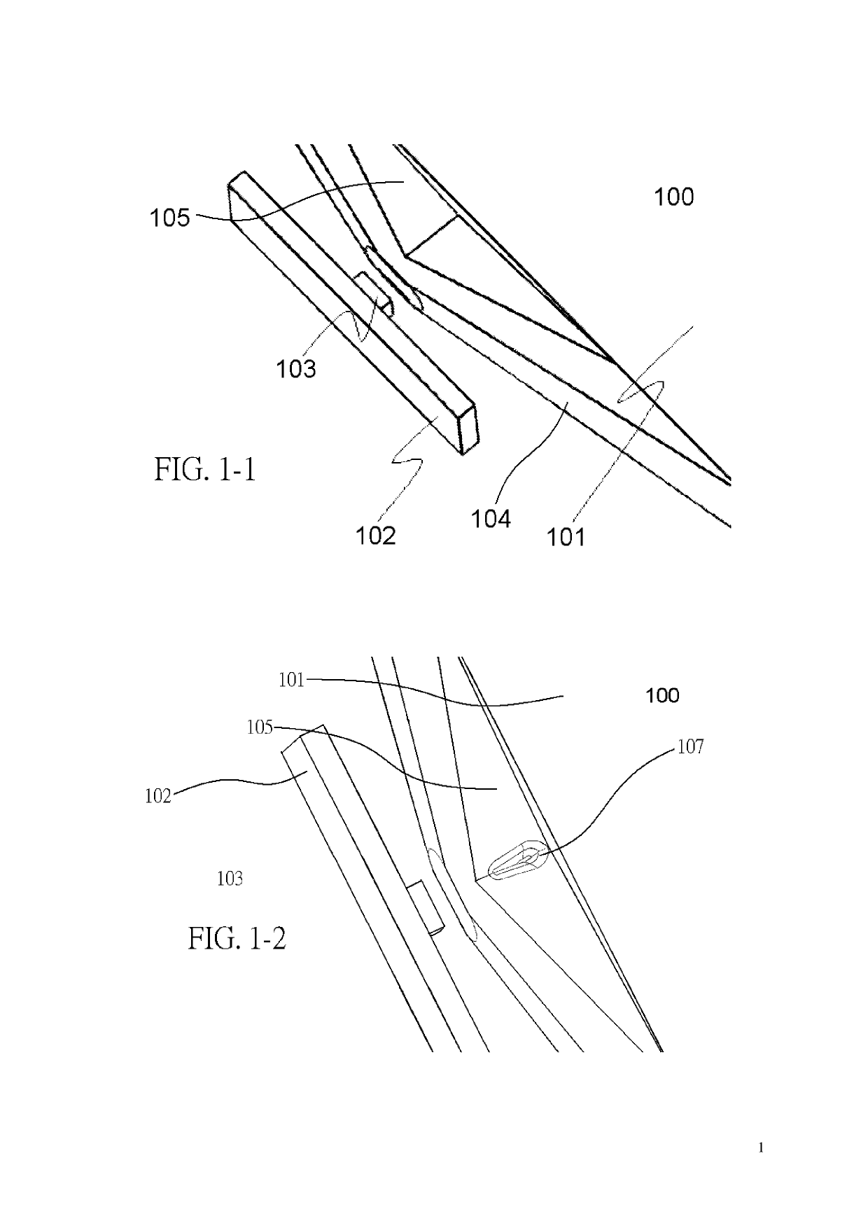

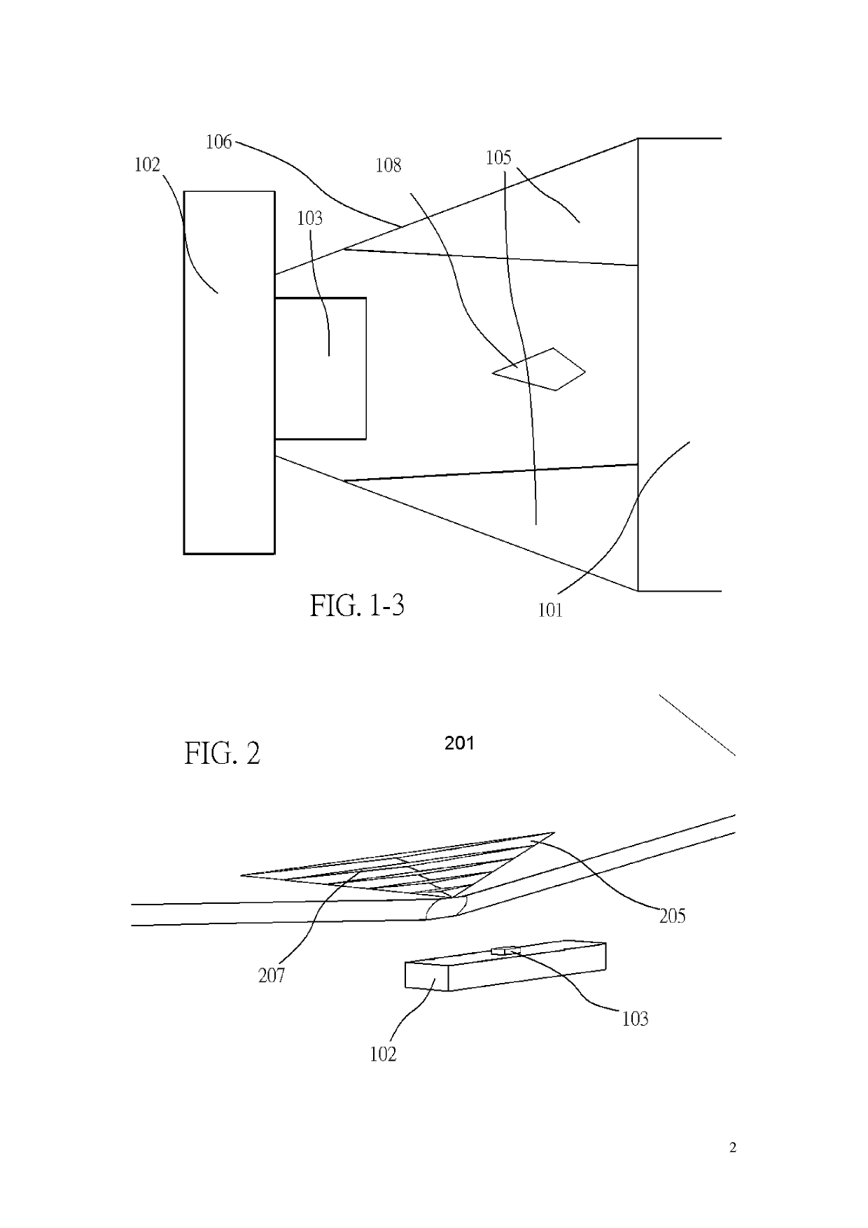

Please referring to FIG. 1-1, there is provided an embodiment of LED backlight unit 100, in accordance with present disclosure. FIGS. 1-1 is an explore perspective view of directly couple LED backlight unit. A light guide plate 101, a kind of transparent resin, for example PMMA, can be formed injection molding machine. By way of total internal reflection (TIR), the light guide plate 101, which can allow the light propagate therein. Similar as prior art, there is a set of dot pattern (not present here) on the active surface of the backlight unit opposite side, which can redirect the source light (here is LED light) by reflection vertically to the active surface. That is the briefly mechanism of backlight unit. A light modulation structure dispose on the light guide plate 101 surface near the edge, where in the dark area of the light guide plate 101 the surface. Please reference the FIG. 1-1, the light modulation structure on the light guide plate 101 surface is a sunken cavity with triangle shape, which structure can be formed at the light guide plate 101 injection molding process. Please refer FIG. 1-1, a lateral light collection structure 104 dispose on the light guide plate 101, where at the aside the emitting surface of the LED 103. In present disclosure, the lateral light collection structure 104 can collected the wild angle light of the LED 103, which made beam profile of the LED 103 more convergent.

In addition, a circuit board 102 in FIG. 1-1, for example is a general PCB such as FR4, a LED (light emission diode) 103 disposed thereon. The LED 103 could be a white light LED or other colors, the manner of its couple to the circuit substrate, could be traditional way, for example, SMD packages or bare die package, wafer-level packaging size of ways and so on. The present disclosure of the embodiment, preferably using bare die package such as chip on board (COB) or others like to connected with the circuit board. Referring to FIG. 1-1, the LED 103 provide the lighting source to the light guide plate 101, which through the circuit board 102 provide the power, the LED 103 lighting on to provide the necessary light source, project to the light guide plate 101.

Conventional LED backlight unit design, the LED dispose to the light guide plate 101 with a little space, the LED light emitted, over through the air the light incident light guide plate 101, that cause a chunk of coupling lost therein. In present disclosure preferably direct couple the LED 103 and the light guide plate 101, by using insert molding process. As known the insert molding processes, which can let the molding plastic direct couple other material, such as the LED or other component. In this embodiment, the insert molding processes let the light guide plate 101 direct coupled the LED 103 also even the circuit board 102. In present disclosure of embodiment, the light of LED 103 can directly propagate in the light guide plate 101, without any coupling lost.

Please refer the FIG. 1-1, as shown in a light modulation structure 105 dispose on the edge of the light guide plate 101, which close to the LED. In present disclosure of embodiment, the light modulation structure 105 is a sunken cavity or depression on the surface of the light guide plate 101. Furthermore, the light modulation structure 105 in FIG. 1-1 compose a triangular shape, with the central part of the deep depression, the edge part of the shallow depression, and there can seem forming slope surface in front of the LED light emitting surface. In present closure of embodiment, the light modulation structure can reflect the light of emit from the LED, and changing the light direction from the LED by the TIR method, which that changing the LED original beam profile, and that say the light modulation structure there is. Please refer to FIG. 1-3, this diagram shows the side view of FIG. 1-1, this structure can more easily perceive, that the light modulation structure 103 developed a surface on the light guide plate 101, that the light of the LED can be re-distribution. Moreover, the light modulation structure can easily understanding, that one wished to changing the original beam profile of the backlight, that can disposed the light modulation structure with a proper design.

In general, the design of the light source incident into the light guide plate, with no other structure design, which is designed to enhance the efficiency of light coupling model at most, the light source distribution, that just let it been. The present disclosed in this embodiment, the light modulation structure can covert the LED 103 of light distribution, to change LED 103 light distribution curve. In present disclosure of embodiment, the light modulation structure 105are designed as a triangular shape, where the tip of triangular against the LED emitting surface, and the middle of shape with more deep denting, where compared the two side, that means provide a structure disturbed the LED 103 beam profile. Moreover, the light modulation structure 105, which disposed in the dark area of the backlight unit, that can fit off-the-shaft of the art, that means this embodiment can deploy as soon as ready.

Please reference FIG. 1-2. The backlight unit 100 can be disposed another structure designed to enhance the LED103 of light modulation. Please refer to FIG. 1-2, a hollow structure 107 dispose within the light modulation structure 105. As the diagram, the hollow structure 107 can let the LED 103 emitting light reflected by the TIR method. In present closure, it can easily understanding that the hollow structure 107 and the light modulation structure 105 can be formed at the light guide plate 101 molding process, and also can be formed by after processes, such as by laser cutting or diamond cutting after the molding processes. In present disclosure, the cavity shape in FIG. 1-2 the hollow structure 107, which can also change the source of the light distribution, this design concept can be converted to produce an air interface, making light of this interface in order to experience total internal reflection principle, and also can seem as been a transforming of the light modulation structure.

Please refer to FIG. 1-3, FIGS. 1-3 is another cross-sectional diagram of FIG. 1-1, in present disclosure also can disposed a inner structure 108, where compose in the light guide plate 101 among of the light modulation structure 105. As FIG. 1-3, the inner structure 108, in this diagram, with a streamline shape similar with tear drop. In this diagram also can understanding, that emitting light from the LED 103, will be reflected by the inner structure 108. In present disclosure of the inner structure 108 can form at the molding process of the light guide plate 101 forming, more actually, by insert molding process. That means the inner structure 108 could be made by a high reflective material or a material which with high reflective surface, such as coating high reflective material on surface. The inner structure 108 for in the light guide plate, also understand that can be form after injection molding process, which by the laser cutting.

In addition, from the present closure of embodiment, FIG. 1-3 shows a slope shape on the light guide plate 101, which is a cross-sectional light collection structure 106. From the diagram of the FIG. 1-3, some portion of the light of the LED 103 in traditional design will escape to the air, which can be collected by the cross-sectional light collection structure 106. Further, that can easily understanding, the light collection structure 106 can not only collecting escaping light but also can modulate the LED 103 beam profile. In present disclosure of embodiment, the light modulation structure 105, the lateral light collection structure 104, cross-sectional light collection structure 106, the hollow structure 107 and the inner structure 108 all of that can achieved the function of light modulation, which transformed beam profile of the LED 103. More over can understand that all above structures can applying at the light guide plate 101, or separately or there's combined.

In general, the beam profile of LED emitting light, which can seem as lambertian distribution, which has a more intensive at the central, and lower strength light at the wide-angle. The characteristic of the LED lambertian distribution, with the traditional design of the light guide, the LED source for backlight applications easily lead to backlight intensity on both sides of the corner of the lower and central of the strong light. In industrial application, the backlight unit will apply plurality of LED, that means the lambertian distribution of the LED characteristic can cause the light un-uniformity or/and inefficiency. In present disclosure of design, which modulated the light beam, that made the structures can re-modulated the light distribution of LED 103, and achieved more efficiency and uniformity in backlight light application.

About the process of insert molding, which coupled the LED 103 and the light guide plate 101 directly, thus can led the light of the LED 103 propagated in the light guide plate 101 without extra media, such as air. Considering the process, that can easily convinced the process can connected the LED 103 and the light guide plate 101 without any other media. From above, the processes alternated as follow. The LED 103 mount on the circuit boards 102, that use of die package (COB), followed by the light guide plate 101 placed on the front, then mount on the circuit board 102 on the LED 103 and between the light guide plate 101, there are some of the space, followed by poured into the glue to achieve the purpose of using in one. Pouring into the manner in which the glue can be used fixtures, such as vacuum equipment at the other end, or in a vacuum environment to carry out operations glue feeding. Furthermore, the more to reach this goal, the process can also be the LED 103 process can use the die package (COB) is attached to the circuit board 102, and placed in plastic mold, injection use of embedded technology, the LED 103 and the circuit board 102 directly on the production of the light guide plate 101, to become one.

In addition, the LED 103 light source be the Lambertian distribution, that is, the direction of the longitudinal section of all light, are all similar to the Lambert distribution. But the backlight is a thin transparent sheet of plastic, the LED 103 light source in the light guide, which the vertical direction—Y direction. Because of the LED 103 light source with the portion of the light at wilder angle, will escaped from the light guide plate 101 from the Y direction, causing light loss. On the other hand, aside the LED 103 laterally—X direction, still had the portion of the light at wilder angle that hardly used. In traditional design of backlight unit can hardly collected the portion of light, but in present disclosure of embodiment can easily overcame. By using variety structures, that can improved the light efficiency of the backlight unit.

The light modulation structure 105 design can also be curved or of any concave parabolic on the light guide plate 101 surface, oval face design backlight, modulating the LED 103 light source more precisely, and then converted the light distribution curve, to achieve uniform backlight light source to enable backlight light source the highest utilization. LED backlight unit, which use traditional design, through the traditional LED components to surface mount technologies, combined with the PCB board, and LED ready light on the entrance side of the plate, and backlight LED components from the edge with a gap. To understanding, the present disclosed, conversion of LED beam profile with the design concept, especially the light modulation structure 105 or others, can also be applied to conventional LED backlight unit design.

As shown in the diagram, the light modulation structure 105 of its symmetrical design, the light modulation structure 105 of its wedge-shaped pockets on both sides for asymmetric design to reach both sides of the light source sub-different needs of the Department. In general, if used in a variety of LED array formed, or the LED light source placed in the corners, which can understood the light modulation structure 105, with its wedge-shaped pockets for asymmetrical design.

### Design Using LED Backlight Array Pockets

Please refer to FIG. 2, there is provided an embodiment of LED backlight unit 200, which is another present disclosure of embodiment. The circuit board 102 in FIG. 2, for example is a general PCB such as FR4, the LED 103 disposed thereon, which connected with circuit board 102. Furthermore, the LED 103 could be a white light LED or other colors, the manner of its couple to the circuit substrate by bear die package. The light guide plate 101, which can be connected with the LED 103 and the circuit board 102 by insert molding process, liked above disclosure. An array light modulation structure 205 dispose on the surface of the light guide plate 101. Please refer FIG. 2, the array light modulation structure 205 similarly in shape of the light modulation structure 105. Where there the array light modulation structure 205 with multiple surfaces or facets disposed on the light guide plate, which structures can enhanced the capability of the light modulation of the light, the LED 103 beam profile.

This design approach can also expand the present disclosure of this embodiment, within a design as a micro-array facet or ramp, due to the internal LED light source in the light guide plate 101 for internal total reflection, which can be designed to more than one micro-reflective surface (not shown here), its design principle and the array light modulation array 205 similar structure. In present disclosure, the method of the array light modulation array 205 structure, which similar to the design principles of fresnel lens. Furthermore, the present disclosure the micro-reflective surface can easily understanding with different reflection angle with the surface of the light guide plate 101, which for modulating variety angle of light to the direction, which pre-design by the designer.

The fresnel lens may be required curvature of the lens to the surface more decentralized alternative to achieve the same curvature but the purpose of saving space, the design concept, so too, modulated light source will be divided into many small curved arc. Furthermore, the array light modulation array 205 can also be modulated light source array with the former one embodiment of the depression surface, each surface has a slope or surface micro-arrays to further increase the performance of light modulation.

Similarly, the present disclosure of embodiment can also introduced above structures, combined the variety structures, to increase design freedom, and increased efficiency. For example, in the hollow structure 107 and/or inner structure 108, which combined with the array light modulation array 205.

Overall, all cases of design can with the implementation of the array light modulation structure 205, which to increase design flexibility and the ability of light modulation. Implementation of the design example above can also be applied to the LED 103 array light source, used in large-size LED backlight modules, which use multiple LED light source to the corresponding number of concave design.

To Corner Shape Design with LED Backlight

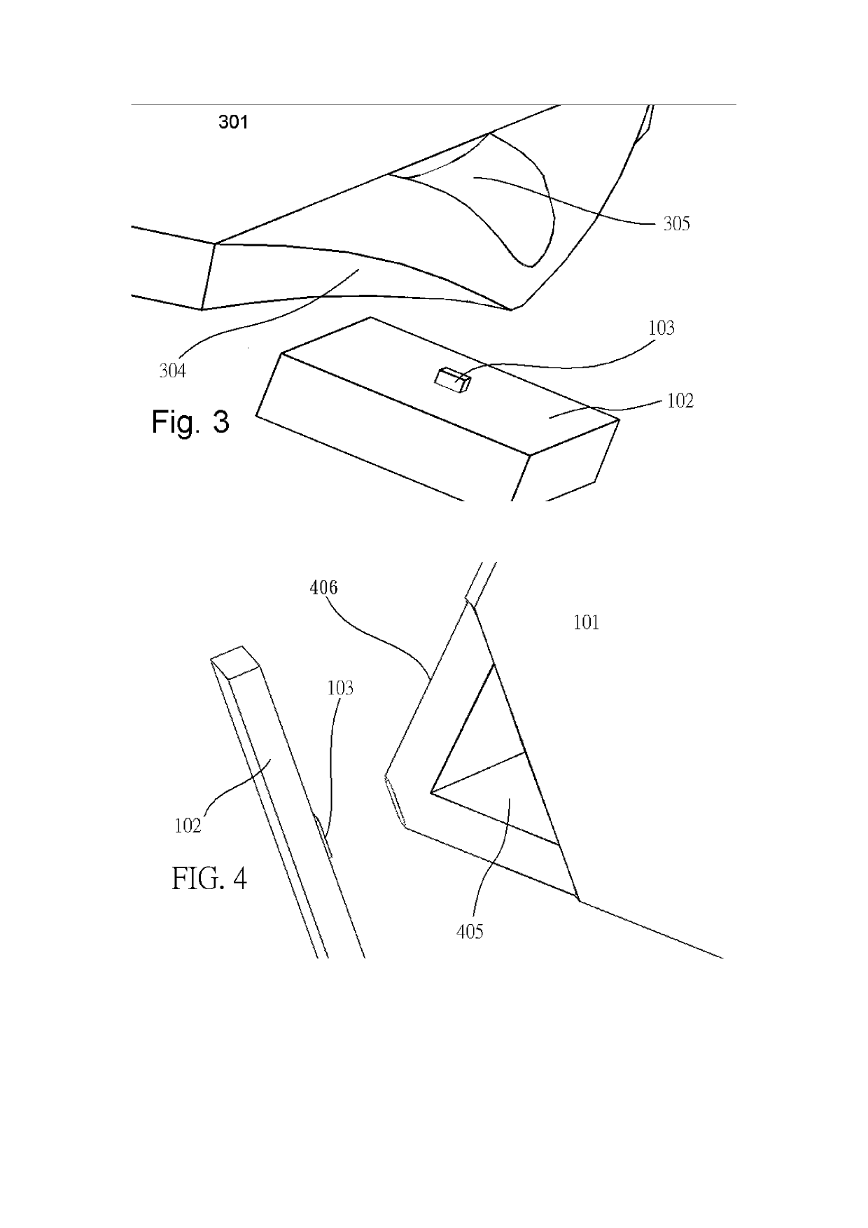

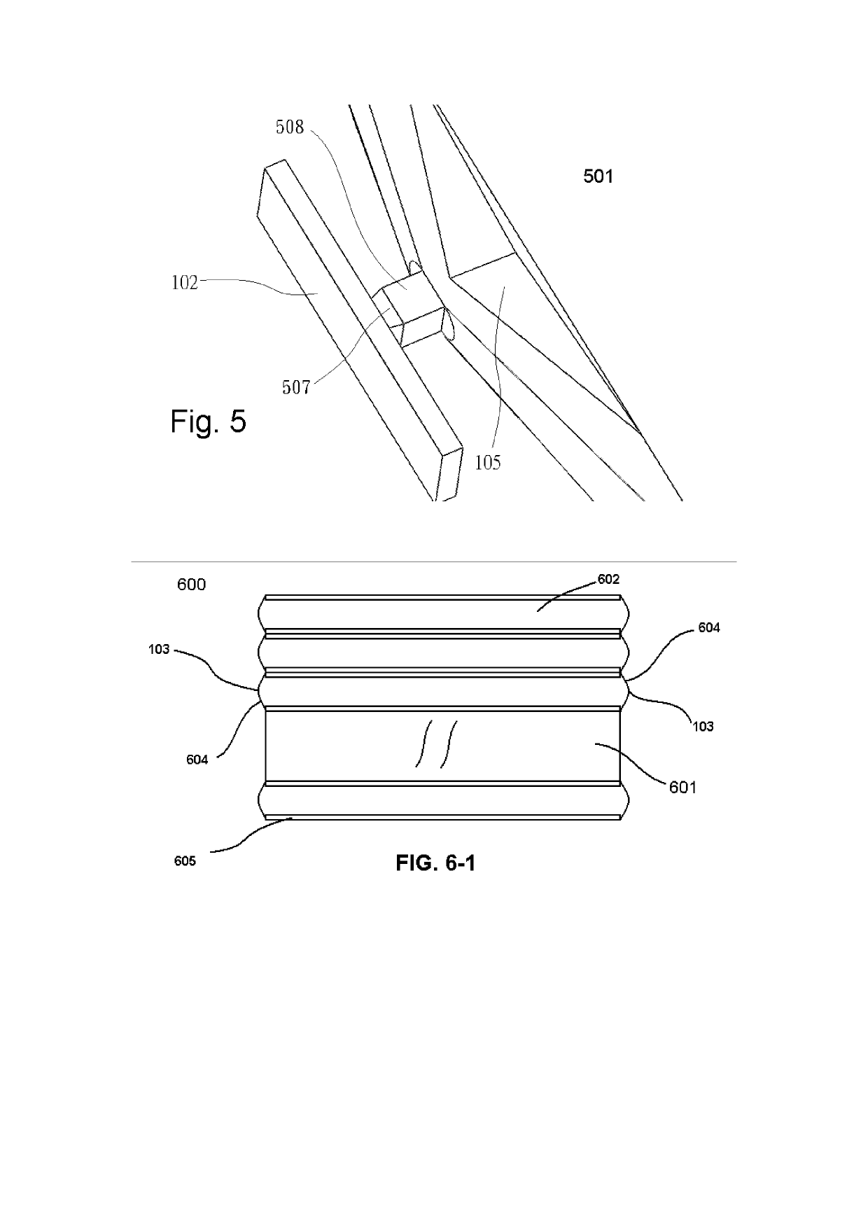

Please refer to FIG. 3, as shown LED 103 installed on circuit board 102 on the installation of light guide plate 101 smooth direction and the direction of the same, this embodiment of the light side in LED 103 vertical. In general, side-in,backlight module, and a smooth light incidence direction perpendicular to the implementation of the case is different. Figure shown, light guide plate 101 in the original design as a point of transition, in view of the icon in its twists and turns about 90 degrees. In general, the implementation of the foregoing cases, the light modulation structure design needs a backlight length, as the adjustment of the light uniformity, angular-shaped design can reduce the length of this section backlight, and must match the general backlight LCD, so the overall thickness can not change.

On the other hand, has a corner design can increase the backlight LED light source light mixing distance, so the design of mixed light and change the LED light curves with structural design, comparison will be easier. Light guide plate 101 as shown in the design of the concave 305, which is designed as a surface along the turning point of light guide 101, to design a structure of a downward depression. Described by the former, the design of this structure into the set with the light directed to the role of the other direction, that this design can also change the incident direction of travel of the light source to achieve the modulated light source with light curve purposes.

Because this design can increase the distance traveled light, which increases the optical path length, so can increase the light uniformity. Furthermore, this design also available in full-color LED light source, that is R, G, B application, the light source of optical path length is longer, by R, G, B light mixture of light and then in the light guide plate 101 backward pass, so we can obtain uniform mixing of the three-color light source, without increasing the actual length of the backlight.

In addition, there is advantage in this embodiment, which in the LED backlight design, thermal dissipation became a major consideration. When the LED in operated, if the temperature rises, LED color will shifted; the other hand, the LED of the temperature increase will result in reduced efficiency of LED light and color shifted, excessive temperature raising will cause the lower LED life. Therefore, high-performance LED backlight design, need to consider the LED operating temperature stability, which requires sound thermal design. As shown, the present disclosure can be to light guide plate 101 turned 90 degrees, compared with prior disclosure, the circuit board 102 and the LED 103 which combined to a LED circuit board, with LCD flat screen with parallel, that can led LED circuit board thermal dissipation design more easily. Such as can mount on the exterior parts (not shown in the drawings).

### Embodiment Four Corners of the LED Light Source Designed to Backlight Design

Please refer to FIG. 4, which is another present disclosure of embodiment, this embodiment is the LED 103 light source will be disposed at the corner of the light guide plate 101. In particular, the embodiment disclosed by the design approach can significantly improve the light efficiency, on the small-size backlight applications. In the small area backlight unit, such as mobile phones or other handheld systems LCD screens, the use of single LED light source designs. Single LED light source design has many advantages, such as color temperature or light intensity without considering the inequality. This embodiment can be used in single LED light source, the LED light source installed at one corner of the backlight.

Please refer FIG. 3, the LED 103 to be a light source, where disposed at a corner of the light guide plate 101. As the diagram shown, the LED 103 disposed on the circuit board 102, the LED 103 of light emission surface which vertical direction right to the diagonal of the light guide plate 101. As shown in present diagram, a corner light modulation structure 405 dispose on the light guide plate 101, where adjacent to the direction of the LED 103 of emission surface, as in the aforementioned embodiment, the design approach for the concave design. Please refer FIG. 3, a curvature surface 406 dispose on the corner of edge of the light guide plate 101, where aside the corner light modulation structure 405. Same as above disclosure, the LED 103 and the circuit board 102 can also connected with the light guide plate 101 directly, which by the insert molding process.

Although, the LED light source design at the corner of light guide, has been proposed. However in traditional design, it still can't easily cope with the LED light source position of the alignment, the coupling efficiency, and the uniformity. In present disclosure, which structure can overcome this problem, especially with insert molding technology, which formed the light modulating surface on the light guide plate 101, the light modulation structure.

The present disclosure of embodiment, the design process can be as follow. First connect the circuit board 102 and the LED 103 by bear die package such as COG or CSP, where the circuit board can have electric component if necessary, which to made a LED circuit board. And then applied the insert molding technology, which the process of formed the light guide plate 101, and which with the corner light modulation structure 405 and the curvature surface 406 structures pre-tooling on the mold. At the this time, the LED circuit board disposed in mold of the light guide plate 101 of the proper place, and then engaged the injection molding process, which formed the light guide plate 101 with the corner light modulation structure 405 and the curvature surface 406 structures, and also coupled the LED circuit board directly at the same time.

In the single LED backlight application, the backlight unit usually been a rectangular, for that so, the light distribution of the LED 103 will be different at the two side. As the mention above, the present disclosure designed can apply for variety of structural combinations. It also can easily understanding, the corner light modulation structure 405 can be designed as asymmetry, that means the two of the corner light modulation structure 405 of the triangular structure can be different area size or different sunken depth or both, which can led the light distribution of the LED 103 of two side can with different portion of light intensity. According the mention of above, that can easily understanding the present disclosure of the corner light modulation structure 405 and the curvature surface 406, which with the asymmetry structure that can met the deferent light distribution.

### Use of R, G, B LED Light Source Backlight Design

In this embodiment, the present disclosure is about a backlight unit for the TFTLCD R, G, B color sequential application. The technique trend of the backlight unit for TFTLCD displayer maybe the R, G, B color sequential lighting displayer. But the traditional design had some problem very difficult to solved, such as the color mixing. The present disclosure of embodiment, which provided a structure, that can be used for R, G, B LED light source TFTLCD backlighting design. By using of R, G, B LED light source can be implemented using the aforementioned cases of design, such as using the first implementation of the example design, the R, G, B LED light source closely to the die packages arranged. However, this application should be considered to color uniformity, such as the design uses the R, G, B LED light source to die packages closely arranged, although in theory each LED color light will be mixed into a uniform white light from the post.

To solve this problem, please refer to FIG. 4, which is the cross-sectional diagram of the present disclosure of embodiment, especially applied for TFTLCD R, G, B color sequential application. In FIG. 4 shows, where a light guide plate 101 is located on the right of the FIG. 4, in which a light modulation structure 105 disposed on the light guide plate 501, which modulated the light, that is used to convert the light distribution. Please refer in FIG. 4, the designed of a circuit board 502 in FIG. 4 of the left, its structure and principles of design and implementation of the above cases come first. And further please refer FIG. 4, a color LED 503 disposed on the circuit board 502, which the color LED 503 are a set of LED group, such as R, G, G, B fore dies arrangement, which can be similar with traditional design.

More over, a light collection structure 509 disposed on the circuit board 502. Please refer FIG. 4, which can saw the light collection structure 509 disposed with a conical shape structure 507 with surface had high reflection coating, which shape can properly adapted the color LED 503 in center of the conical shape. In front of the color LED 503 emission surface, a light pipe structure 508 disposed, where between the color LED 503 and the light modulation structure 105.

In traditional white light application for color LED, which LED die displaced closely, and using variety technique to bonded on the PCB board. In present disclosure, the color LED 503 disposed on the circuit board 502, which can be implemented as the above embodiment. The color LED 503 is located on the circuit board 502, and the use of die package (COB, chip on board) or wafer scale package (CSP, chip scale package) or other miniature packaging technology. As shown, the implementation of the method to use for the LED die package (COB, chip on board) or wafer scale package (CSP, chip scale package) and other small-scale packaging technology, by embedding injection molding (insert molding), the LED package in the light guide plate 501, as shown through the LED light will light pipe structure 508, the cross-sectional area slightly larger than the share of the color LED 503 chips packaging area.

When the color LED 503 emitting light, there light source propagated through the light pipe structure 508, with the mixing of light, to achieve the purpose of uniformly mixed light sources of the color LED 503. The present disclosure can has a shorter distance to be used as LED mixed light. Generally, the use the light pipe structure 508 design, which can design followed the cross-sectional length of mixing light source is about 2.5 times of the high. In present disclosure, since the LEDs chip size small, so light pipe structure 508 can be controlled at 4 mm length, that dimension can similarly as traditional design.

Furthermore, the present disclosure of embodiment preferably, using the insert molding, which will led light guide plate 501, the circuit board 502 and the color LED 503 combined in one process, and also with the conical shape structure 507. Please refer FIG. 4, the color LED 503 disposed in the conical shape structure 507, and there high reflection surface and the conic shape, that can reflected the light of emission from the side of the LED die, increase the light use efficiency. Because of a good chunk of the light emitting from the edge of LED die, especially low current LED. So that the present disclosure of the embodiment can be more efficiency compared than traditional design.

Please refer disclosure of the embodiment, the color LED 503 package in the central interior shell, where the center of the conical shape structure 507. In the present disclosure of embodiment, the color LED 503 die be wire welding electrode connected to a bonding pad, then the traditional PCB manufacturing process connected to the PCB (the figure is not drawn). The light distribution of color LED 503 lighting, the use of the present disclosure, exploited the structure of the light distribution transformation, followed by LED light output. As shown, a hollow of the LED light distribution curve transfer structure, the FN in the LED light output, the LED light source of the light distribution curve, converted into backlight required light distribution curve.

Diagram of the LED light distribution curve transfer structure, its highly reflective material for plastic injection molding to the hollow structure made of, or is made of light transparent plastic tube. LED lights change with the light distribution curve structure and the incident backlight mouth backlight placed in the top right graph, the three were placed as shown for the tight junction. This design approach from the above principles, LED light distribution curve will be LED with light curve at structural changes, the light incident backlight when a more appropriate light distribution curve, to increase the optical coupling and light use efficiency.

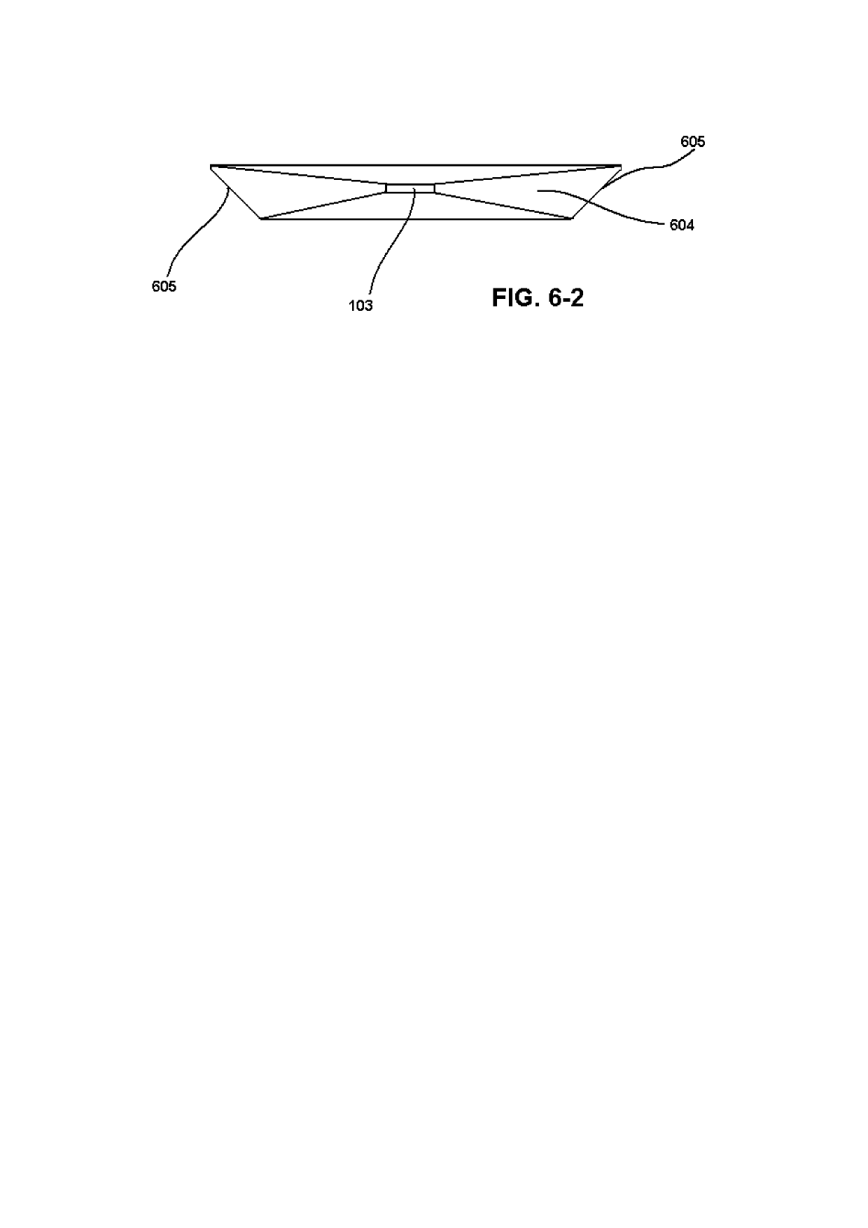

Please refer the FIGS. 6-1, there is anther embodiment of present disclosure, which for the structural design of smart source. TFT LCD backlight unit designs, requiring power efficiency, and therefore began to backlight design so-called “Smart Lighting”, which concept had proposed. In general, the concept of smart lighting, there original ideal from the direct type backlight panels, the direct type backlight unit using multiple light sources distributed in the LCD panel at the variety area separately, when the LCD drive circuit driving the LCD light valve from the top of the screen to the bottom with the screen scanning, LCD screen on the order of the light valve is thus open sequentially. Direct type backlight board design, the LED light source applications, can also switch the order with the LCD driver circuit, simultaneous switching LED light source, power saving purposes. The structural design, which is in accordance with the above principles, to achieve power saving.

Please refer the FIGS. 6-1 the design structure based on the backlight unit 600 top view, as shown in the design of the backlight unit 600, which a long-stripe region 602 disposed on the light guide plate 601, from top to bottom of the light guide plate 601, the long-stripe region 602 divided into the region over with a long bar. In present disclosure, a LED 103 corresponds to the slab on both sides of the long-stripe region 602 of the central location. Please refer the FIGS. 6-1, the LED 103 of the light from a light collection structure 604 into the long-stripe region 602 region, curve designed of the light collection structure 604 of the LED 103 aside, which collecting light source with curve surface.

From the above disclosure of embodiment design, there still had a circuit for carried the LED 603 (not present here), and also the LED 103 disposed on the circuit board with the bear die package preferably. Furthermore, the connection method of the LED 103, the circuit board and the light guide plate 601 can exploited insert molding technology as the same. Also in present of disclosure, the LED 603 can be disposed on the both sides of the vortex of the long-stripe region 602.

In addition, as shown in FIGS. 6-1 shows, the structure of the long-stripe region 602 of the light guide plate 601, there also can dispose a light modulation structure on the surface(not present here), to enhanced power efficiency. In above disclosure, the light modulation structure can disposed on the surface of the light guide plate 601, where at the aside of LED 603 separately. In this embodiment, the light of view angle traveling in the structure of the long-stripe region 602 very small, so that the light modulation structure may had disposed on the two side of the LED 603, to converged the light beam of the LED 603.

Please refer FIGS. 6-2, which is one of the long-stripe region 602 structure of the side view in present disclosure of the embodiment, where a slope surface structure 605 disposed on the two side of the long-stripe region 602, that means every one of the long-stripe region 602 are made by two of the slope surface structure 605. And just the slope surface structure 605 disposed on the light guide plate 601, that made the light guide plate 601 separately many of region, which forming the long-stripe region 602.

In present disclosure, the slope surface structure 605 can led the incident light by total internal reflection more easily, when the light met the surface of the long-stripe region 602, which can led the light propagated in advanced, and enhanced the power efficiency. Furthermore, from the above disclosure there can applied micro-structure design, which enhance the capability of the light modulation. According, the slope surface structure 605 can comprised the array of the micro-structure or multiple of subsurface structure on the slope surface structure 605. Moreover, in present disclosure of embodiment, forming of the structure of fore mention, which can applied the insert molding process. So the process of the present disclosure, which can made a LED circuit board first. And using insert molding process coupling the light guide plate 601 and the LED circuit board.

Skills are familiar with this area, though the writing better clarify the above examples, however, its not to limit the creative spirit. Not out of the creative spirit and scope of the changes made and similar in configuration, should be included in the below of claim within, this range should cover all such changes and a similar structure, and should make the most broad interpretation.

What is claimed is:

1. A method of making a edge type LED backlight unit processes, which comprising:
providing a circuit board, where the circuitry on the circuit board, and which can provide electrical connection to electronic components;
disposing a one or a plurality of LED on the circuit board as the backlight unit lighting source, to be a LED circuit board, which by use bear die package on the circuit board, such as COB processes probably without further passivation;
applying insert molding, to forming a light guide plate, by way of pre-placed the LED circuit board on mold where at the edge of the light guide plate, that couple the light guide plate and the LED circuit board directly, and that make the LED totally immerse in the light guide plate, that make the light emit from the LED direct propagate in the light guide plate without any medium between.

2. The method of claim 1, wherein the LED package is formed by flip-chip package, chip scale package or wafer level package.

3. The method of claim 1, which the insert molding process, further comprising a light tube structure at the edge of the light guide plate.

4. The method of claim 1, wherein the light guide plate can comprising a corner shape structure, for elongating the LED light path.

5. The method of claim 1, wherein the edge of the light guide plate can further comprise a reflection structure aside the LED, which for collecting the LED emitting light.

6. The method of claim 1, wherein near the edge of the light guide plate can further comprise a one or plurality of light modulation structure on the light guide plate, which for modulating the LED emitting light to change LED beam profile.

7. The method of claim 6, the light modulation structure on the light guide plate can further comprising a plurality of array structure on the light modulation structure to enhance the light modulation.

8. The method of claim 1, the LED disposed on the light guide plate, whereat the one of the corner of the light guide plate.

9. The method of claim 1, the light modulation structure can be alternated by the insert molding processes, wherein disposed high reflection material structure in the light guide plate.

10. A edge type LED backlight unit assembly, which comprising:
a circuit board, and which can provide electrical connection to electronic components;
a one or a plurality of LED light source, located above the circuit board to be a LED circuit board, as a backlight unit light source;
a light guide plate, whereat the edge of light guide plate has the LED circuit board.
a light modulation structure, whereon the light guide plate, which corresponding and near to the direction of the LED light emitting surface, which for modulating the LED lighting beam profile.

11. The edge type LED backlight unit as claim 10, wherein the light modulation structure can as a sunken structure on one side of the light guide plate or both, where place near the LED light emitting surface.

12. The edge type LED backlight unit as claim 10, wherein the light modulation structure, the sunken structure can be symmetrical or non-symmetrical, and/or the sunken structure can further comprising a plurality array mini-structure thereon.

13. The edge type LED backlight unit as claim 10, wherein the light modulation structure, disposed in the dark area of the edge type LED backlight unit.

14. The edge type LED backlight unit as claim 10, wherein the light modulation structure, which further dispose a pair of the light modulation structure, where place at near the two side of the LED light of the emitting surface, which made the LED source of light convergent.

15. The edge type LED backlight unit as claim 10, wherein the LED cam further disposed on the four corners of one of the light guide plate.

16. A edge type LED backlight unit using in smart lighting displayer assembly, which comprise:
a circuit board, and which can provide electrical connection to electronic components;
a one or a plurality of LED light source, located above the circuit board to be a LED circuit board, as a backlight unit light source;
a TFT panel, which using for showing image;
a control circuit, which control the TFT panel and the LED lighting;
a light guide plate, the LED light source transmitting light in an appropriate structural design, the light source into surface light source;
a plurality of bevel structures, whereon the light guide plate, which the bevel structures formed a plurality rectangular area on the light guide plate;
wherein the every edge rectangular area dispose a LED, which provide lighting source of the rectangular area and the control circuit control the rectangular area brightness separately, which provide different the rectangular area brightness according the image condition.

17. The edge type LED backlight unit using in smart lighting displayer as claim 16, can further apply insert molding or similarly process, which make the light guide plate couple the LED directly.

18. The insert molding process as claim 16, can further apply insert molding or In-mold decoration processes dispose high reflection material structure in/on the light guide plate.

19. The bevel structures as claim 16, further comprise a plurality of array structure on the bevel structures or/and a curved structure, whereat the edge the light guide plate and located on both sides of the LED.

20. The light guide plate as claim 16, further comprise a light tube structure, where between the edge of the light guide plate and the LED.
